(19) United States
(12) Patent Application Publication
(10) Pub. No.: US 2011/0162181 A1
(43) Pub. Date: Jul. 7, 2011

(54) Device for polling piezoelectric element and polling method using the same

(75) Inventors: Jae Hun Kim, Seoul (KR); Jae Woo Joung, Suwon (KR); Yun Sung Kang, Suwon (KR); Ju Hwan Yang, Suwon (KR)

(73) Assignee: SAMSUNG ELECTRO-MECHANICS CO., LTD., Suwon (KR)

(21) Appl. No.: 12/805,296

(22) Filed: Jul. 22, 2010

(30) Foreign Application Priority Data
Jan. 7, 2010 (KR) 10-2010-0001276

(51) Int. Cl. H04R 17/00

(52) U.S. Cl. 29/25.35

(57) ABSTRACT

A device for polling a piezoelectric element includes: a polling chamber in which a plurality of piezoelectric elements are disposed; a power supply unit providing voltage to poll the piezoelectric elements; a capacitance measurement unit connected with the piezoelectric elements to measure the capacitance of the piezoelectric elements; and a switching system connected with the power supply unit and the piezoelectric elements within the polling chamber, and selectively providing the voltage of the power supply unit to the piezoelectric elements.

### CROSS-REFERENCE TO RELATED APPLICATIONS

This application claims the priority of Korean Patent Application No. 10-2010-0001276 filed on Jan. 7, 2010, in the Korean Intellectual Property Office, the disclosure of which is incorporated herein by reference.

### BACKGROUND OF THE INVENTION

1. Field of the Invention

The present invention relates to a device for individually polling unpolled piezoelectric elements by using a switching system connected with a plurality of piezoelectric elements disposed within a chamber for polling, and a polling method using the same.

2. Description of the Related Art

A piezoelectric element is utilized in various sectors and, in particular, it is used as a driving unit of an inkjet print head of an inkjet printer.

In general, an inkjet print head is a structure for converting an electrical signal into a physical force to discharge ink in the form of a droplet through a small nozzle.

Recently, a piezoelectric inkjet print head has also been employed in an industrial inkjet printer. For example, ink produced by melting a metal such as gold, silver, and the like, is jetted onto a printed circuit board (PCB) to directly form a circuit pattern, or the piezoelectric inkjet print head is used for industrial graphics, to manufacture a liquid crystal display (LCD) or an organic light emitting diode (OLED), or for a solar cell, and the like.

Here, a piezoelectric actuator providing a driving force for ink discharging includes a plurality of piezoelectric elements formed by polling a piezoelectric material in a bulk state which has been fabricated through screen printing, aerosol deposition, sputtering, and the like.

Here, polling refers to a process in which a piezoelectric material in a bulk state is provided to between upper and lower electrodes and voltage is applied to between the upper and lower electrodes to generate an electric field to make dipoles of domains adjacent to the piezoelectric material gradually consistent in their direction by the electric field.

However, such a polling process has a problem in that the plurality of piezoelectric elements have a deviation due to various factors such as manufacturing equipment, a working environment, and the like.

### SUMMARY OF THE INVENTION

An aspect of the present invention provides a device for individually polling unpolled piezoelectric elements by using a switching system connected with a plurality of piezoelectric elements disposed within a chamber for polling, and a polling method using the same.

According to an aspect of the present invention, there is provided a device for polling a piezoelectric element, including: a polling chamber in which a plurality of piezoelectric elements are disposed; a power supply unit providing voltage to poll the piezoelectric elements; a capacitance measurement unit connected with the piezoelectric elements to measure the capacitance of the piezoelectric elements; and a switching system connected with the power supply unit and the piezoelectric elements within the polling chamber, and selectively providing the voltage of the power supply unit to the piezoelectric elements.

The switching system may be connected with the capacitance measurement unit and the piezoelectric elements within the polling chamber.

The polling device of a piezoelectric element may further include: a controller connected with at least one of the power supply unit, the capacitance measurement unit, and the switching system and controlling its driving.

The controller may include a display unit.

The polling chamber may include a temperature sensor for measuring temperature when the piezoelectric elements are polled.

The polling chamber may be maintained at a high temperature when the piezoelectric elements are polled.

The polling chamber may include an exhaust for discharging gas after polling is performed.

According to another aspect of the present invention, there is provided a polling method including: disposing a plurality of piezoelectric elements within a polling chamber; polling the piezoelectric elements by applying the voltage of a power supply unit to the piezoelectric elements by using a switching system; measuring the capacitance of the polled piezoelectric elements with a capacitance measurement unit to sort a piezoelectric element having a smaller measurement capacitance than a pre-set capacitance; and selecting the piezoelectric element having a smaller measurement capacitance than the pre-set capacitance by the switching system, and providing voltage to the piezoelectric element to poll it.

The piezoelectric element may be polled at a high temperature.

After the piezoelectric element is polled, gas may be discharged.

At least one of the power supply unit, the capacitance measurement unit, and the switching system may be driven by the controller.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a device for polling a piezoelectric element according to an exemplary embodiment of the present invention;

FIG. 2 is a schematic view of polling all of a plurality of piezoelectric elements;

FIG. 3 is a schematic view of polling a piezoelectric element whose piezoelectric performance is not uniform; and

FIG. 4 is a flow chart illustrating the process of a polling method using a polling device for polling a piezoelectric element according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

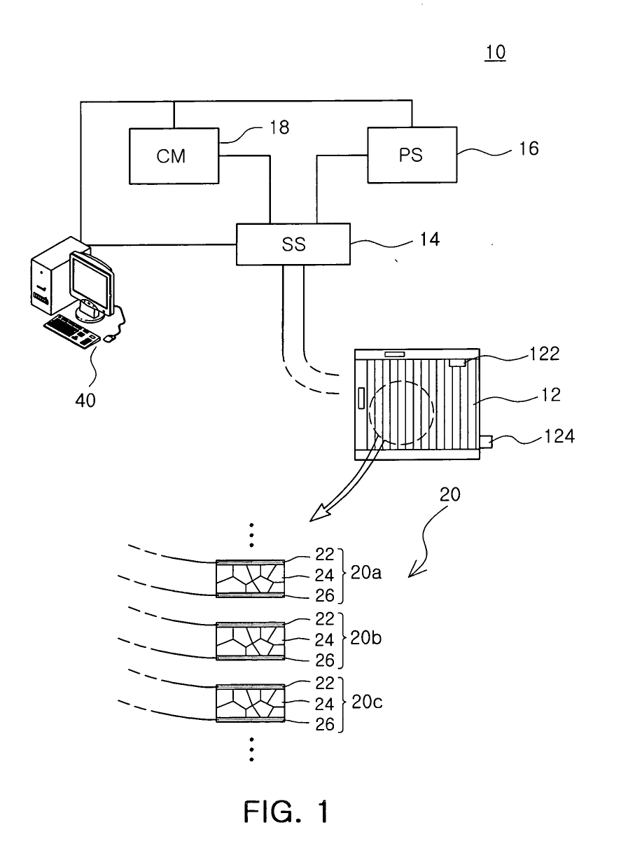

FIG. 1 is a schematic block diagram of a device for polling a piezoelectric element according to an exemplary embodiment of the present invention.

With reference to FIG. 1, a polling device 10 for polling a piezoelectric element according to an exemplary embodiment of the present invention includes a polling chamber 12, a power supply unit 16, a capacitance measurement unit 18, and a switching system 14.

The polling chamber 12 is where polling is performed, in which a plurality of piezoelectric elements 20 are disposed. Here, the piezoelectric elements 20 has a concept of including individual piezoelectric elements 20a, 20b, and 20c which are formed as a piezoelectric material 24 is disposed between an upper electrode 22 and a lower electrode 24, respectively.

In the process of polling the piezoelectric elements 20, the piezoelectric elements 20 are maintained at a high temperature and in a high voltage state within the polling chamber 12.

Thus, the polling chamber 12 may include a temperature sensor 122 for measuring temperature when the piezoelectric elements 20 are polled. Also, the polling chamber 12 may include an exhaust 124 for removing a gas generated after polling is performed.

The power supply unit (PS) (or a voltage providing unit) 16 may be electrically connected to apply voltage to the individual piezoelectric elements 20a, 20b, and 20c, . . . so as to be polled. Here, the power supply unit 16 may provide a pre-set voltage required for polling.

The capacitance measurement unit (CM) 18 is a device electrically connected with the individual piezoelectric elements 20a, 20b, 20c, . . . to measure the capacitance of the individual piezoelectric elements 20a, 20b, 20c, . . . .

The switching system (SS) 14 is connected with the power supply unit 16 and the piezoelectric elements 20a, 20b, 20c, . . . within the polling chamber 12 and may selectively provide voltage of the power supply unit 16 to the piezoelectric elements 20a, 20b, 20c, . . . .

Here, the switching system 14 may be connected with the capacitance measurement unit 18 and the piezoelectric elements 20a, 20b, 20c, . . . within the polling chamber 12.

Among the piezoelectric elements 20a, 20b, 20c, . . . , the piezoelectric elements 20a, 20b, 20c, . . . in a state of being switched on with the switching system 14 can receive voltage from the power supply unit 16 and their capacitance can be measured by the capacitance measurement unit 18.

The polling device 10 for polling the piezoelectric elements having such a configuration may further include a controller 40 connected with at least one of the power supply unit 16, the capacitance measurement unit 18, and the switching system 14, and controlling its driving.

The controller 40 may include a display unit allowing a switching connected state or capacitance measurement values of the piezoelectric elements 20a, 20b, 20c, . . . , the temperature within the piezoelectric chamber 12, and the like, to be observed.

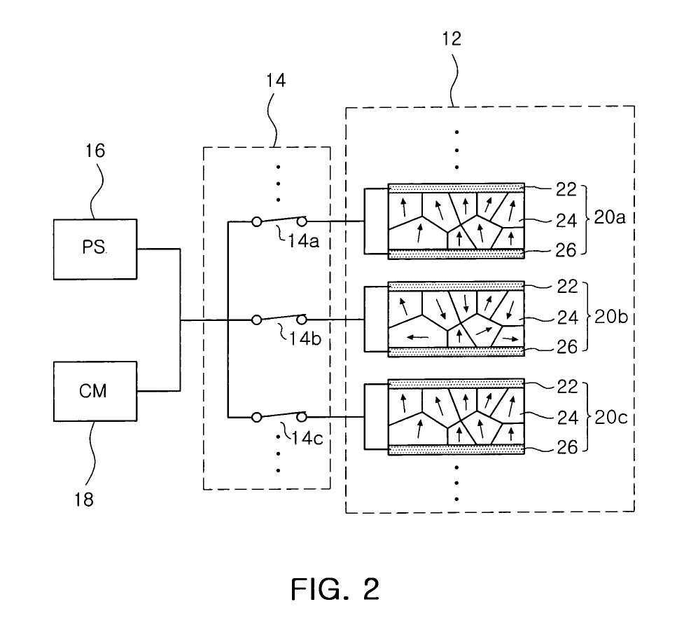

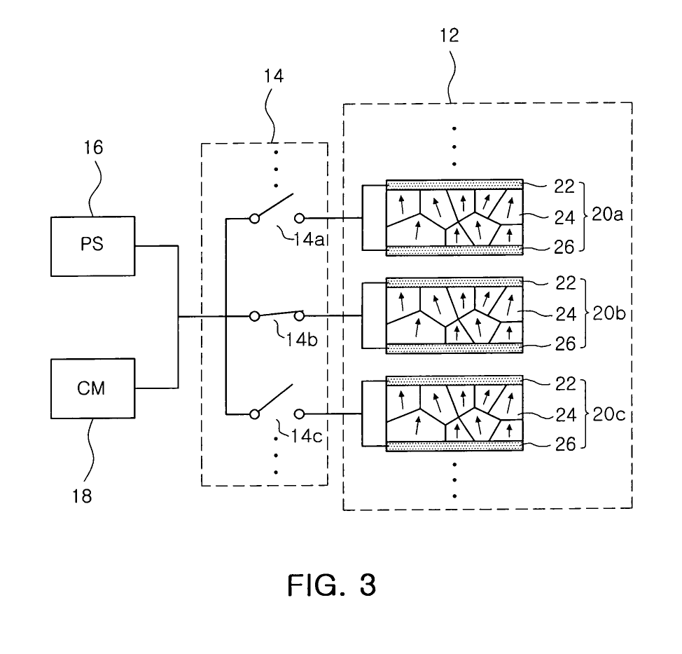

FIG. 2 is a schematic view of polling all of a plurality of piezoelectric elements, and FIG. 3 is a schematic view of polling a piezoelectric element whose piezoelectric performance is not uniform.

With reference to FIG. 2, it is noted that the piezoelectric elements 20a, 20b, 20c, . . . are polled.

The piezoelectric elements 20a, 20b, 20c, . . . are all connected with switches 14a, 14b, and 14c . . . , of the switching system 14, but it happens that the piezoelectric element 20b is not polled.

Namely, an electric field is generated in the piezoelectric material 24 toward the upper electrode 22 and the lower electrode 26 by applying voltage to the piezoelectric element 20b, but the directions of dipoles of the contiguous domains of the piezoelectric material 24 are not consistent even by the generated electric field.

In this case, a capacitance value of the piezoelectric element 20b measured by the capacitance measurement unit 18 may not be the same as those of the piezoelectric elements 20a and 20c in the normal state.

With such a piezoelectric element 20b present, the normal piezoelectric elements 20a and 20c are switched off and only the piezoelectric element 20b is provided with voltage so as to be polled as shown in FIG. 3.

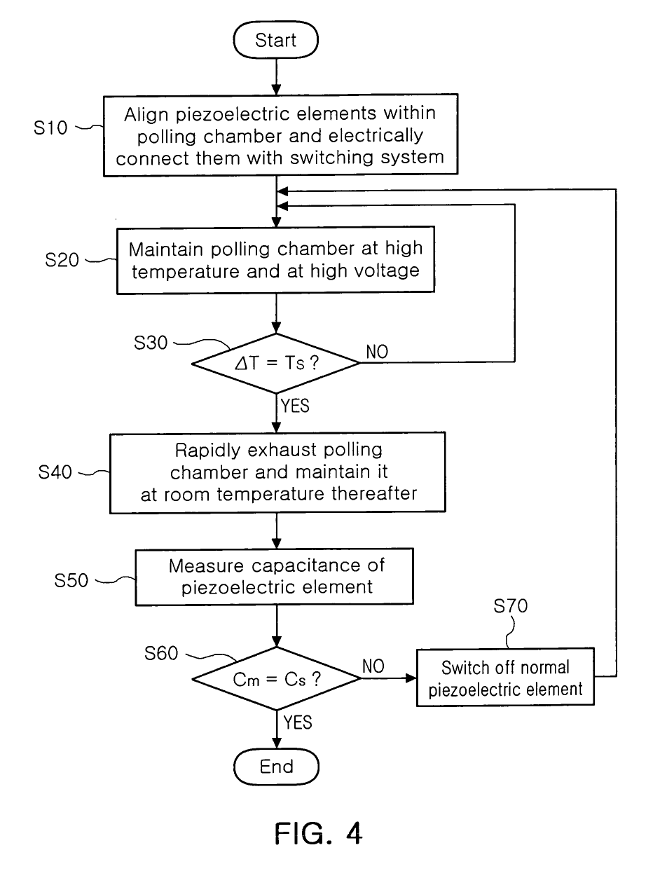

FIG. 4 is a flow chart illustrating the process of a polling method using a polling device for polling a piezoelectric element according to an exemplary embodiment of the present invention.

The process of a polling method using a polling device according to an exemplary embodiment will now be described with reference to FIG. 4.

First, a plurality of piezoelectric elements electrically connected with the switching system 14 may be disposed within the polling chamber 12 (S10). The polling chamber 12 is maintained at a high temperature and at a high voltage level (S20), and the power supply unit 16 applies voltage to the piezoelectric elements 20a, 20b, and 20c, . . . during a pre-set time duration (Ts) (S30).

After the polling is primarily performed, the exhaust 124 of the polling chamber 12 is open to quickly exhaust air, and then, room temperature is maintained (S40). Thereafter, the capacitance of the piezoelectric elements 20a, 20b, and 20c, . . . is measured (S50). The measured capacitance (Cm) is compared to a pre-set capacitance (Cs) (S60) to check whether it is normal.

When the measured capacitance (Cm) falls short of the pre-set capacitance (Cs), the piezoelectric elements in a normal state are switched off in order to poll a corresponding unpolled piezoelectric element (S70). And then, the unpolled piezoelectric element is polled again, and polling is then completed.

As set forth above, in the polling device and polling method using the same according to exemplary embodiments of the invention, the uniformity of piezoelectric characteristics of the plurality of piezoelectric elements can be improved without being affected by a working environment.

In addition, polling and measurement of capacitance of a polled piezoelectric element are performed by the single device, the speed of the operation can be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. A device for polling a piezoelectric element, the device comprising:
a polling chamber in which a plurality of piezoelectric elements are disposed;
a power supply unit providing voltage to poll the piezoelectric elements;
a capacitance measurement unit connected with the piezoelectric elements to measure the capacitance of the piezoelectric elements; and
a switching system connected with the power supply unit and the piezoelectric elements within the polling chamber, and selectively providing the voltage of the power supply unit to the piezoelectric elements.

2. The device of claim 1, wherein the switching system is connected with the capacitance measurement unit and the piezoelectric elements within the polling chamber.

3. The device of claim 1, further comprising:
a controller connected with at least one of the power supply unit, the capacitance measurement unit, and the switching system and controlling its driving.

4. The device of claim 1, wherein the controller comprises a display unit.

5. The device of claim 1, wherein the polling chamber comprises a temperature sensor for measuring temperature when the piezoelectric elements are polled.

6. The device of claim 1, wherein the polling chamber is maintained at a high temperature when the piezoelectric elements are polled.

7. The device of claim 1, wherein the polling chamber comprises an exhaust for discharging gas after polling is performed.

8. A polling method comprising:
disposing a plurality of piezoelectric elements within a polling chamber;
polling the piezoelectric elements by applying the voltage of a power supply unit to the piezoelectric elements by using a switching system;
measuring the capacitance of the polled piezoelectric elements with a capacitance measurement unit to sort a piezoelectric element having a smaller measurement capacitance than a pre-set capacitance; and
selecting the piezoelectric element having a smaller measurement capacitance than the pre-set capacitance by the switching system, and providing voltage to the piezoelectric element to poll it.

9. The method of claim 8, wherein the piezoelectric element is polled at a high temperature.

10. The method of claim 8, wherein after the piezoelectric element is polled, gas is discharged.

11. The method of claim 8, wherein at least one of the power supply unit, the capacitance measurement unit, and the switching system is driven by the controller.
